(19) United States
(12) Patent Application Publication
(10) Pub. No.: US 2017/0284605 A1
(43) Pub. Date: Oct. 5, 2017

(54) DISPERSANTS AND DISSOLVERS FOR REMOVAL OF ASPHALTENE DEPOSITS

(71) Applicant: Lonza, Inc., Allendale, NJ (US)

(72) Inventors: Kevin E. JANAK, Blauvelt, NY (US); Steven J. COLBY, New Providence, NJ (US)

(73) Assignee: Lonza, Inc., Allendale, NJ (US)

(21) Appl. No.: 15/475,850

(22) Filed: Mar. 31, 2017

Related U.S. Application Data
(60) Provisional application No. 62/317,000, filed on Apr. 1, 2016.

(51) Int. Cl. F17D 3/12; B08B 9/032; C11D 3/20; C11D 3/43; C11D 3/30; C11D 3/28

(52) U.S. Cl. CPC F17D 3/12; C11D 3/30; C11D 3/28; C11D 3/201; C11D 3/43; B08B 9/032

(57) ABSTRACT

A cleaning solution for the removal of asphaltene deposits includes a first dispersant comprising a quaternary ammonium compound and a second dispersant comprising a pyridinium compound.

### CROSS-REFERENCE TO RELATED APPLICATIONS

This application claims the benefit of U.S. Provisional Patent Application Ser. No. 62/317,000, filed Apr. 1, 2016, the contents of which are incorporated herein by reference.

### BACKGROUND

The present disclosure relates to oil and gas recovery and production, and more specifically, to dispersants and dissolvers for the removal of asphaltene deposits.

Asphaltenes are a component of crude oil defined as a solubility class, i.e., as a component of crude oil insoluble in n-pentane (C5 asphaltenes) or n-heptane (C7 asphaltenes) but soluble in aromatic solvents such as toluene. Asphaltenes exist as black, shiny, friable solids and are complex, polyaromatic, macrocyclic structures with an overall varied composition, containing not only carbon (C), oxygen (O), sulfur (S), and nitrogen (N), but also small amounts of transition metals, primarily consisting of nickel (Ni), vanadium (V), and iron (Fe) ligated complexes. These large, overall “flat” molecules have molecular weights typically at 750 Daltons (g/mol) and in the range of 300-1,400 Daltons, but readily form larger aggregates that can deposit to block reservoir pores near a wellbore, in production tubing, and in downstream pipelines and processing facilities. As such, asphaltene deposition, remediation, and inhibition are important considerations for both upstream and downstream processes throughout the oil mining industry.

Although asphaltenes are a component of what eventually becomes asphalt for roadways and other applications, their presence and corresponding potential for deposition can lead to significant operational issues. In upstream processes, asphaltenes can precipitate and deposit at many points along the production system, such as inside the formation (e.g., the near-wellbore region of the production pipe), deposit and buildup in the wellbore, gunk and deposit in flowlines, generate solids in the separator, as well as pumps, wellheads, safety valves and additional surface facilities. This can lead to reduced production or shut-in downtime. Fouling in downstream operations can lead to coking and catalyst deactivation during processing or upgrading, as high temperatures and vacuum conditions are required in the processing of asphaltene-rich oils.

A range of chemistries are typically used for asphaltene inhibition, dispersion, or dissolving. Inhibitors prevent the aggregation of asphaltene molecules and ultimately shift the onset of asphaltene flocculation pressure. Inhibitors are often polymer or resin products. Inhibitors function by delaying the onset point of deposition, which allows for moving asphaltene precipitation out of the wellbore to a point in the production system where it can be dealt with more easily. Hence, inhibition is not complete inhibition but a delay in the kinetics of deposition. Inhibitors behave as threshold inhibitors, analogous to polymers in scale deposit control but do not provide complete protection and are expensive. Dispersant chemistries do not affect the onset point of asphaltene flocculation but are able to keep asphaltenes suspending in the crude oil, by reducing particle size and maintaining intermolecular repulsive forces (i.e., impacting particle zeta potential). Dispersant chemistries are typically non-polymeric surfactants. Dissolvers are typically solvents or solvent packages that are batch treated to remove asphaltene deposits. Typical dispersants and dissolvers, however, do not allow for the use aromatic solvents.

Therefore, improved dispersants and dissolvers are desired that can boost dissolution and dispersion (i.e., improve the solubilization properties) of asphaltenes in aromatic solvents.

### SUMMARY

In some aspects, example cleaning solutions for the removal of asphaltene deposits include a first dispersant comprising a quaternary ammonium compound and a second dispersant comprising a pyridinium compound. The example cleaning solutions can further include an alcohol. In some aspects, the alcohol can be selected from the group consisting of: ethanol, methanol, isopropanol, or mixtures thereof.

In some aspects, the first dispersant can be selected from the group consisting of: trimethyl alkyl quaternary ammonium compounds, dialkyldimethyl quaternary ammonium compounds, alkyl dimethyl or diethyl benzyl ammonium compounds, polyethoxylated quaternary ammonium compounds, salts thereof, or mixtures thereof. In other aspects, the first dispersant can be selected from the group consisting of cocotrimethyl ammonium chloride, didecyl dimethyl ammonium chloride, didecyl dimethyl ammonium carbonate, didecyl dimethyl ammonium bicarbonate, dioctyl dimethyl ammonium chloride, octyl decyl dimethyl ammonium chloride, benzalkonium chloride, benzalkonium hydroxide, N,N-didecyl-N-methyl-poly(oxyethyl) ammonium propionate, N,N-didecyl-N-methyl-poly(oxyethyl) ammonium lactate, salts thereof, or mixtures thereof. In some aspects, the first dispersant is a dialkyldimethyl quaternary ammonium compound, or a salt thereof. In some aspects, the first dispersant is didecyl dimethyl ammonium chloride.

In some aspects, the pyridinium compound can be selected from the group consisting of: cetyl pyridinium, 1-(phenylmethyl)-pyridinium, 1-ethylmethyl pyridinium, 1-methyl pyridinium, 1-ethyl pyridinium, 1 propyl pyridinium, 1-butyl pyridinium, salts thereof, and mixtures thereof. In some aspects, the pyridinium compound is a 1-alkylpyridinium chloride salt.

In some aspects, the cleaning solutions for the removal of asphaltene deposits can further include an aromatic hydrocarbon solvent. In some aspects, the aromatic hydrocarbon solvent can be toluene, xylene, or mixtures thereof. In some aspects, the aromatic hydrocarbon solvent comprises a high aromatic naphtha. In some aspects, the cleaning solution is a concentrate. In some aspects, the second dispersant is present at an actives ratio of 1:10 to 10:1 to the concentration of the first dispersant.

In some aspects, a method of removing asphaltene deposits from a system is disclosed that includes flushing a system component having asphaltene deposits with an cleaning solution comprising a quaternary ammonium compound and a pyridinium compound. In some aspects, flushing the system component comprises a batch treatment with the cleaning solution. In some aspects, flushing the system component comprises a continuous treatment with the cleaning solution.

### BRIEF DESCRIPTION OF THE DRAWINGS

FIG. 1 illustrates common asphaltene structures;

FIG. 2 illustrates a well bore system tube with asphaltene deposits;

FIG. 3 illustrates an asphaltene phase diagram;

FIG. 4 illustrates three example cleaning solutions for the removal of asphaltene deposits;

FIG. 5 illustrates test results of a 3% RP in Xylenes-1 and 3% RP in Xylenes-2 formulation as compared to a first Xylene Control;

FIG. 6 illustrates test results of a 3% RP in Xylenes-1 and 3% RP in Xylenes-2 formulation as compared to a second Xylene Control;

FIG. 7 illustrates test results of the 3% RP in Xylenes-1 and 3% RP in Xylenes-2 formulations as compared to both the first and second Xylene Control solutions; and

FIG. 8 illustrates test results of a 3% RP without Xylenes formulation as compared to a xylene control and a 3% RP with Xylenes formulation.

### DETAILED DESCRIPTION

As stated above, the present disclosure relates to cleaning solutions for the removal of asphaltene deposits, which are now described in detail with accompanying figures. It is noted that like reference numerals refer to like elements across different embodiments.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

Crude oil (dead oil, or oil that has lost its gaseous components) is typically characterized in terms of its composition of saturates, aromatics, resins, and asphaltenes (SARA) via laboratory methods for such general fractionation. Correspondingly, asphaltenes are the components of crude oil that are insoluble in n-alkanes such as pentane or heptane but soluble in aromatic hydrocarbons such as toluene or xylenes. A wide range of techniques have been used to study asphaltenes in attempts to characterize them chemically and structurally as part of the overall field of petroleomics. Analytical methods include mass spectrometry, electron microscopy, nuclear magnetic resonance, small-angle neutron and X-ray scattering, ultrasonic spectroscopy, multi-angle dynamic light scattering, fluorescence correlation spectroscopy, fluorescence depolarization, vapor-pressure osmometry, and gel permeation chromatography.

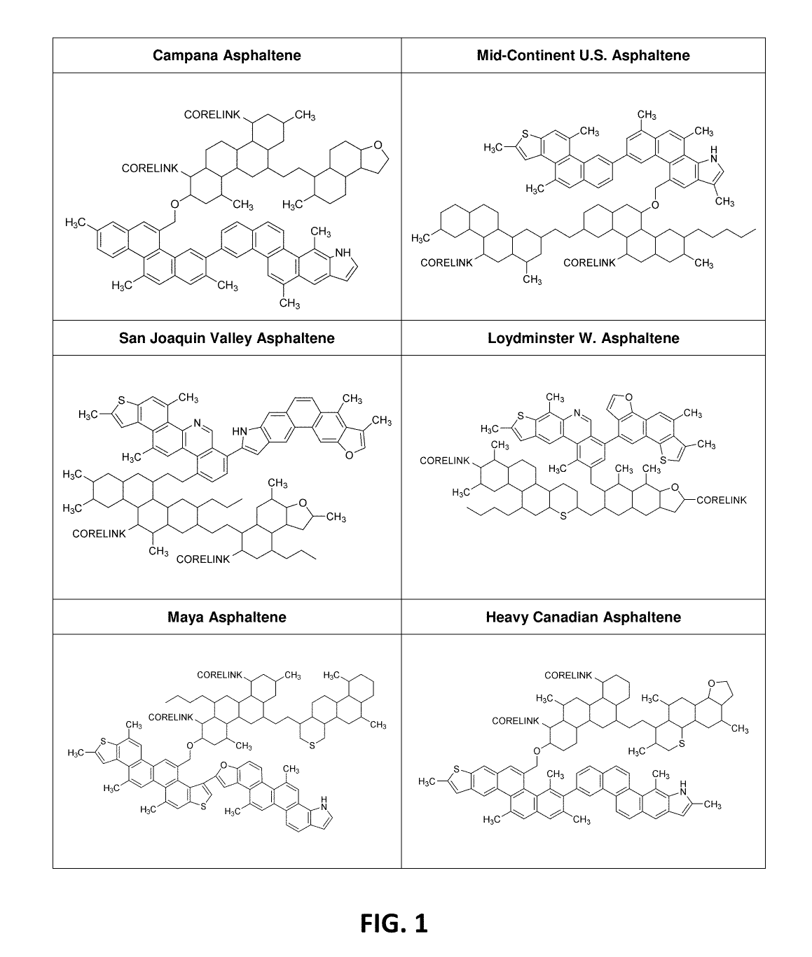

In addition, asphaltene structures have been modeled using computational programs to match NMR spectra of asphaltenes originating from different sources, the resulting compounds are shown in FIG. 1. This modeling demonstrates the complexity of asphaltene structures and the variability that can exist from one reservoir to another.

While asphaltenes exist in a variety of crude oils, problematic oils tend to be localized to about 1% of total world production. Problem areas include Canada, Venezuela, and Kuwait, although asphaltene problems are also noted in Russian reservoirs. The presence of high asphaltene content in a crude oil is not an indicator of the potential for asphaltene deposition problems. Asphaltene precipitation is often observed in light crude oils (high API gravity oils) that contain fairly low amounts of asphaltenes. This is primarily due to the fact that light oils contain large percentages of light alkanes that asphaltenes have limited solubility in at specific temperatures and pressures. Conversely, heavy oils (low API gravity oils), which are also typically rich in asphaltenes as these components provide density to the oil, contain large amounts of additional compounds such as resins which are good asphaltene dispersants and solvents and often do not exhibit as many or frequent asphaltene deposition problems.

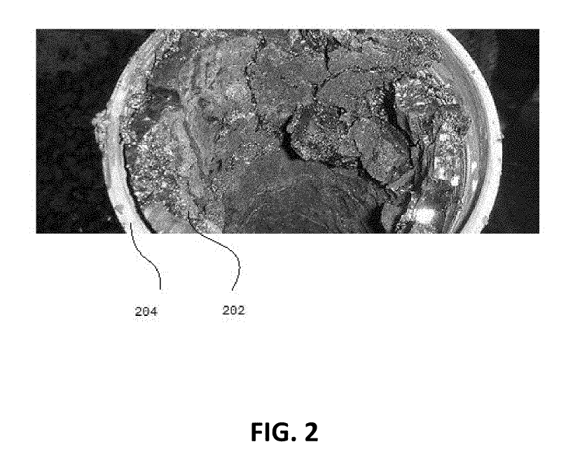

Although they are a component of what eventually becomes asphalt for roadways and other applications, their presence and corresponding potential for deposition can lead to significant operational issues. As illustrated in FIG. 2, in upstream processes, asphaltenes 202 can precipitate and deposit at many points along the production system, such as inside the formation 204 (e.g., the near-wellbore region of the production pipe), deposit and buildup in the wellbore, gunk and deposit in flowlines, generate solids in the separator, as well as pumps, wellheads, safety valves and additional surface facilities. This can lead to reduced production or shut-in downtime. Fouling in downstream operations can lead to coking and catalyst deactivation during processing or upgrading, as high temperatures and vacuum conditions are required in the processing of asphaltene-rich oils.

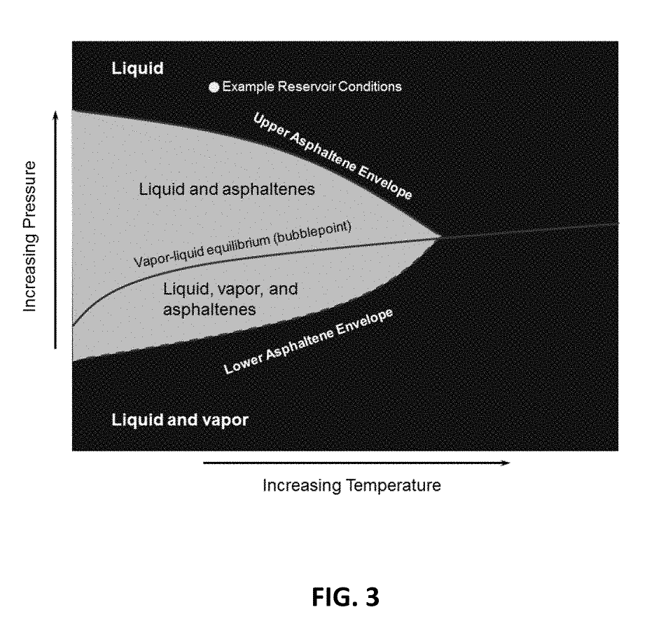

Precipitation and deposition may be caused by a variety of conditions, including changes in pressure, temperature, shear rate, and even composition of the production fluids. These changes are affected and induced by a range of factors, including primary depletion, injection of natural gas or CO2, acidizing treatments, and commingled production of incompatible fluids. Each of these has the potential of destabilizing the asphaltene dispersions in a given crude oil. A general view of asphaltene stability as a function of both pressure and temperature (f(P,T)) has arisen and is depicted in FIG. 3. However, there is a possibility of a minimum in the asphaltene stable region at certain high temperatures and pressures near the bubblepoint.

As mentioned above, a range of chemistry types for asphaltene inhibition, dispersion, and dissolution have been used. The relative performance of different inhibitors and dispersants can be oil specific, with heteroatom components of the crude often dictating what type of chemistry might work. Hence, a series of products and formulations may be screened for determining the best chemistry for a given reservoir and oil type. However, as described above, asphaltenes are defined as being soluble in aromatic hydrocarbons.

As such, formulations that are remediation (i.e., dissolver or dispersant) boosters that can be additive to a dissolver package that includes an aromatic solvent are disclosed herein as cleaning solutions for the removal of asphaltene deposits. As used herein, “cleaning solution” means a formulation that removes asphaltene deposits in a system. That is, a cleaning solution can be a dispersant or dissolver or an additive to solvent, dispersant, or dissolver formulations for the removal of asphaltene deposits.

As such, the present disclosure teaches cleaning solutions having improved cleaning performance. In at least some aspects, these improved cleaning solutions include a first dispersant that is a quaternary ammonium compound and a second dispersant that is a pyridinium compound. Moreover, example cleaning solutions can include an alcohol.

The first dispersant can be a quaternary ammonium compound. As used herein, “quaternary ammonium compound” or “quat” means positively charged polyatomic ions of the structure NR₄⁺, R being an alkyl group or an aryl group. In some aspects, quaternary ammonium compounds can include trimethyl alkyl quaternary ammonium compounds such as cocotrimethyl ammonium chloride; dialkyldimethyl quaternary ammonium compounds such as didecyl dimethyl ammonium chloride, didecyl dimethyl ammonium carbonate, didecyl dimethyl ammonium bicarbonate, dioctyl dimethyl ammonium chloride and octyl decyl dimethyl ammonium chloride, or mixtures thereof; alkyl dimethyl or diethyl benzyl ammonium salts such as benzalkonium chloride and benzalkonium hydroxide; polyethoxylated quaternary ammonium compounds such as N,N-didecyl-N-methyl-poly(oxyethyl) ammonium propionate (Bardap 26) or N,N-didecyl-N-methyl-poly(oxyethyl) ammonium lactate; polymeric betaines, and mixtures thereof. For example, quaternary ammonium compounds can include benzalkonium chloride, didecyl dimethyl ammonium chloride, and didecyl dimethyl ammonium carbonate. In at least one example, the first dispersant is didecyl dimethyl ammonium chloride (“DDAC”). Any suitable anion can be used. For example, quaternary ammonium salts can include carbonate, bicarbonate, halides, phosphates, sulfates, acetates, citrates, nitrates, borates, betaines, saccharinates, methocarbonate, and other suitable anions. In some aspects, the first dispersant can be present in any suitable amount. For example, the first dispersant can be present at an actives ratio of 1:10 to 10:1 to the concentration of the second dispersant. Total combined first and second dispersant actives level can range from 5% to 70%. A typical active level for the first dispersant is 30%.

The second dispersant can be a pyridinium compound. As used herein “pyridinium” means a cationic conjugate acid of pyridine as is shown in Formula 1:

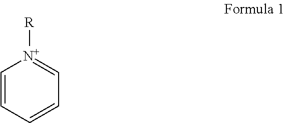

where R is any anion. In some aspects, the pyridinium compound—or pyridine quaternary ammonium compound—can be an alkyl pyridine quaternary ammonium compound or derivatives thereof. For example, the pyridinium compound can be N-substituted pyridinium compounds such as cetyl pyridinium chloride, an alkyl substituted pyridinium compound such as p-alkylpyridinium, and derivatives thereof. For example, 1-alkylpyridinium salts such as 1-alkylpyridinium chloride can be used. For example, alkylpyridinium compounds such as those shown in U.S. Pat. No. 4,115,390 entitled Method of Preparation of 1-alkyl pyridinium chlorides, which is hereby incorporated by reference in its entirety, can be used. In some aspects, 1-(phenylmethyl)-pyridinium, ethylmethyl pyridinium, and derivatives or salts thereof can be used. The pyridinium salts can include anions such as chloride, bromide, fluoride, carbonate, methocarbonate, bicarbonate, sulfate, nitrate, saccharinate, or any other suitable anion. In some aspects, the second dispersant can be present in any suitable amount. For example, the second dispersant can be present at an actives ratio of 1:10 to 10:1 to the concentration of the first dispersant. Total combined first and second dispersant actives level can range from 5% to 70%. A typical active level for the second dispersant is 24%.

As described, example cleaning solutions can include an alcohol. As used herein, “alcohol” means any organic compound in which the hydroxyl functional group (—OH) is bound to a saturated carbon atom. In some aspects the alcohol can include methanol, ethanol, propanol, isopropanol, butanol, tert-butanol, ethylene glycol, propylene glycol, triethylene glycol, diethylene glycol butyl ether, diethylene glycol methyl ether, triethylene glycol methyl ether.

Cleaning solutions, in some aspects, can include a myriad of additional components such as additional solvents, wax crystal inhibitors, dispersants such as polysorbitol or glycerol esters, hydantoin derivatives, and imidazole derivatives. For example, Table 1 illustrates exemplary additional formulation additives and compounds.

TABLE 1
Exemplary Additional Formulation Additives

| Category | Chemistry Type | Example | Comment/Description |
|---|---|---|---|
| Inhibitor | Alkylphenol/aldehyde Resin | Nonylphenol ethoxylate | Typically low MW/ |
| | | resins | Oligomeric to avoid |
| | | | unwanted coagulation |
| ″ | Polyesters, Polyacrylates, | Polymethacrylates | Typically low MW/ |
| | Polyimides, Polyamides | Polyalkylenesuccinimides | Oligomeric to avoid |
| | | Polypyrrolidones | unwanted coagulation |
| | | Polyesteramides | |
| ″ | Lignosulfonates | Sulfonated lignin | |
| ″ | Derivatized asphaltenes | Phosphorylated | |
| | | asphaltenes | |
| Dispersant | Sulfonic acid derivates | DDBSA | Thought to work via acid |
| | | | base interaction and |
| | | | surfactancy²⁴ |
| | Alkyl and Alkylaryl | Isooctyl phosphoric ester | Interact via acid-base |
| | phoshonates and phosphoric | | chemistry and metal ion |
| | esters | | complexation |
| | Amphiphilic/cationic | Oleyl amine/acrylic acid | Alkyl pyridine quats could |
| | surfactants | condensate | fit in this general category |
| | Alkyl imide surfactants | Fatty alkyl amides | DETA Oleyl and TOFA |
| | | Alkyl prrrolidones | imidazoline functionalized |
| | | Alkyl succinimides | derivatives often |
| | | Alkyl/Alkyl amide | referenced |
| | | imidazolines | Hydantoin derivatives fit |
| | Alkylphenolethoxylates | NPEs | Lower EO levels show |
| | | | better performance |
| Dissolvers | Solvents | Toluene | Terpenes also useful for |
| | | Xylenes | waxes |
| | | Dimethylformamide | |
| | | D-limonene (terpene) | |
| | Heterocycle additives | Quinoline derivatives | Akolidines fit in this |
| | | Alkyl pyridine derivatives | category |
| | | N-methyl pyrrolidone | |
| | | Imidazolines | |

In use, the formulations described herein allow for the synergistic or boosted dissolution and/or dispersion of asphaltenes into solvents such as aromatic solvents. In some aspects, the cleaning solution is diluted with solutions containing organic aromatic molecules. As is discussed in the Examples contained herein, this combination of the cleaning solutions described and aromatic solvents results in a synergistic combination. For example, the cleaning solutions can be diluted with monoaromatic hydrocarbons, such as benzene, toluene, ethylbenzene, trimethylbenzenes, and xylene isomers. Exemplary compounds are aromatic hydrocarbons containing one unsubstituted or methyl-substituted benzene ring, however, any suitable dilution component can be used including but not limited to other aromatic hydrocarbons, such as polycyclic aromatic hydrocarbons, including high aromatic naphtha. In some aspects, the dilution component is a mixture of an aromatic hydrocarbon and another organic compound such as an alcohol that is in addition to or is the same alcohol as was described above.

Moreover, in use, the cleaning solution formulations can be used as a periodic batch treatment to well bore system components. As such, in some aspects, the cleaning solution is configured for use as a dissolver additive product that boosts existing dissolver and solvent packages. In this aspect, the additives can include additives to aid in wax removal as described above. In other aspects, the cleaning solutions can be configured to be a dispersant booster that is applied continuously to well bore systems. This can involve testing cleaning solutions via gravimetric methods, including piezoelectric based balances, percent transmission, or flow loop designs. Additionally, in at least some aspects, the cleaning solutions described herein may be utilized in an inhibitor system.

### EXAMPLES

### Example 1

One illustrative example is an cleaning product that is designed to be applied in a Toluene solution utilizing a 90% Toluene/10% Methanol solvent mixture (w/w) at a dosage between 1 to 10% as product (w/w).

In this example, the example cleaning product can be formulated as shown in Table 2. The Concentrations shown in Table 2 are w/w %.

TABLE 2
Example 1 RP Formulation

| Chemical name | CAS-No. | Concentration (%) |
|---|---|---|
| Didecyldimethylammonium chloride | 7173-51-5 | 27.00-33.00 |
| Pyridinium, 1-(phenylmethyl)-, ethyl | 68909-18-2 | 20.00-29.00 |
| methyl derivs., chlorides | | |
| Methanol | 67-56-1 | 28.00-42.00 |
| Ethanol | 64-17-5 | 3.00-5.50 |

In this example, for a given application, a 55 gallon drum of a Toluene formulation is prepared by mixing the Toluene with Methanol. The example RP formulation—referred to as RP in Table 3—is then dosed to the mixed solvent at the following levels in order to achieve desired concentrations:

TABLE 3
Example Dilutions in Toluene/MeOH solutions

| RP | Gallons of Toluene | Gallons of MeOH | Gallons RP |
|---|---|---|---|
| Target Dosage | per Drum | per Drum | per Drum |
| 1.0% | 48.6 | 5.9 | 0.5 |
| 2.5% | 47.9 | 5.8 | 1.3 |
| 5.0% | 46.7 | 5.7 | 2.6 |
| 7.5% | 45.6 | 5.5 | 3.9 |
| 10.0% | 44.4 | 5.4 | 5.2 |

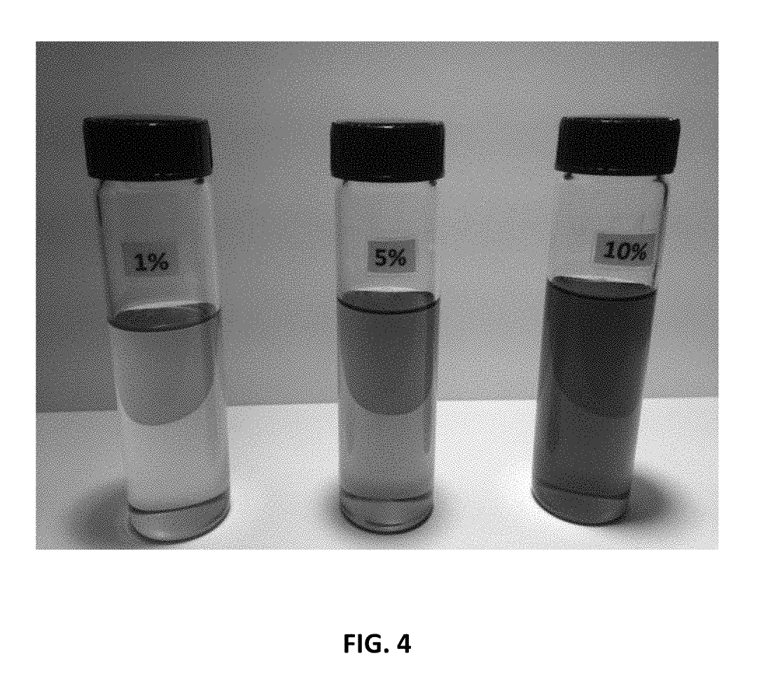

The resulting formulation of toluene, methanol, and RP solution is then mixed thoroughly to ensure homogeneity. Accordingly, example formulations are achieved and are shown in FIG. 4. A 1% solution, a 5% solution, and a 10% solution are shown and have increasing opacity. Furthermore, a 275 gallon tote volume of the above example formulation can be achieved by multiplying the values in Table 3 by a factor of 5. A 325 gallon tote volume of the above example formulation can be achieved by multiplying the values in Table 3 by a factor of 5.91.

### Example 2

The following example formulations include the formulation and testing of example dispersant formulations with an asphaltene deposit sample in a Quartz Crystal Microbalance with Dissipation (QCM-D) monitoring. In the example tests, the Quartz Crystal Microbalance with Dissipation (QCM-D) monitoring system was an electrochemical quartz crystal microbalance eQCM 10M™ obtained commercially from Gamry Instruments and had a total flow cell volume of approximately 40 microliters and comprised a working fluid that contained either test solutions containing the Example 2 RP Formulation described below in Table 4 or control solutions.

TABLE 4
Example 2 RP Formulation

| Chemical Name | CAS-No. | Concentration (% w/w) |
|---|---|---|
| Didecyldimethylammonium | 7173-51-5 | 30% |
| chloride | | |
| Pyridinium quat | 68909-18-2 | 24% |
| Methanol | 67-56-1 | 28-42% |
| Ethanol | 64-17-5 | 3-5.5% |

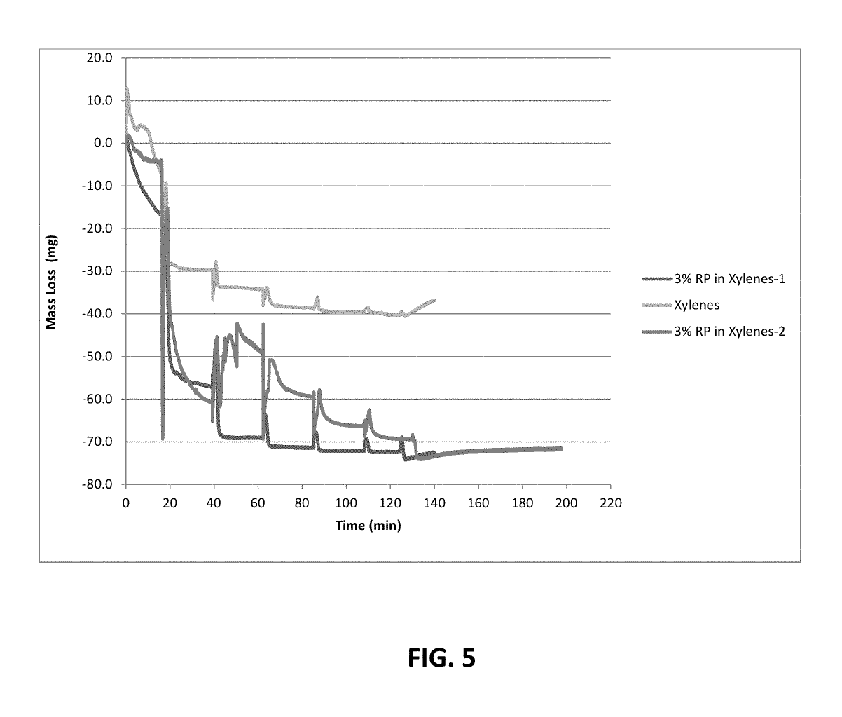

To obtain a first working fluid test sample—referred to as “3% RP in Xylenes-1” in FIGS. 5-7—an Example 2 RP Formulation was formulated as a 3% v/v dispersant sample. That is, the first sample is formulated by combining 3% v/v of the Example 2 RP formulation described in Table 4 in a 90/10 Xylenes/MeOH solution (hence, 97% of the volume is 90/10 Xylenes MeOH). The second working fluid test sample—referred to as “3% RP in Xylenes-2” in FIGS. 5-7 is prepared in the same manner.

Control samples were prepared by producing a 90/10 Xylenes/MeOH solution. The sample asphaltene deposit solution was a system sample that was a combination of waxes, maltenes, and asphaltenes. It was 37% asphaltene by weight.

To test the mass loss of each working fluid, a 10 microliter volume of asphaltene solution was autoinjected (using an in-line autoinjector) at 20 minutes, 40 minutes, 60 minutes, 80 minutes, 100 minutes, and 120 minutes. A 2500 ppm test sample was dispersed in Toluene and added 1 microliter at a time for a total of 25 microliters onto the gold plated area of the crystal, with each microliter being dried after addition. The tests were then repeated to determine if there was user-to-user variability and, if so, to what degree.

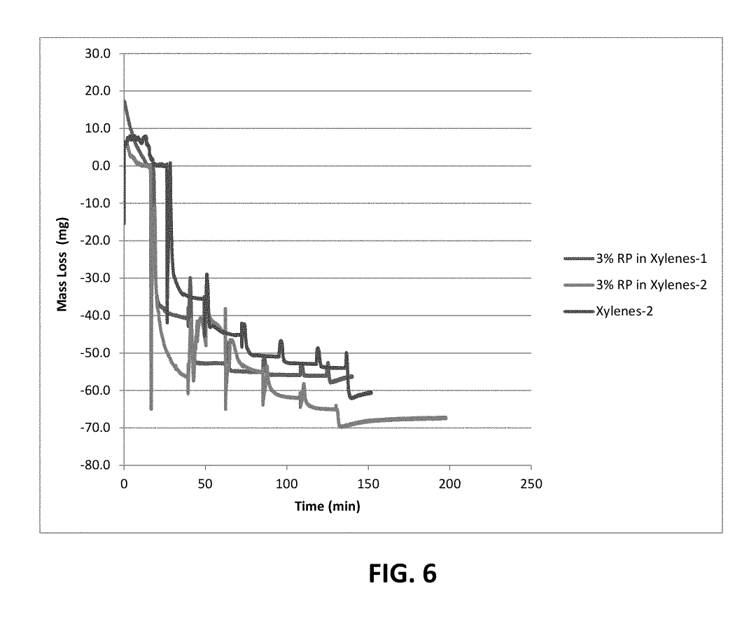

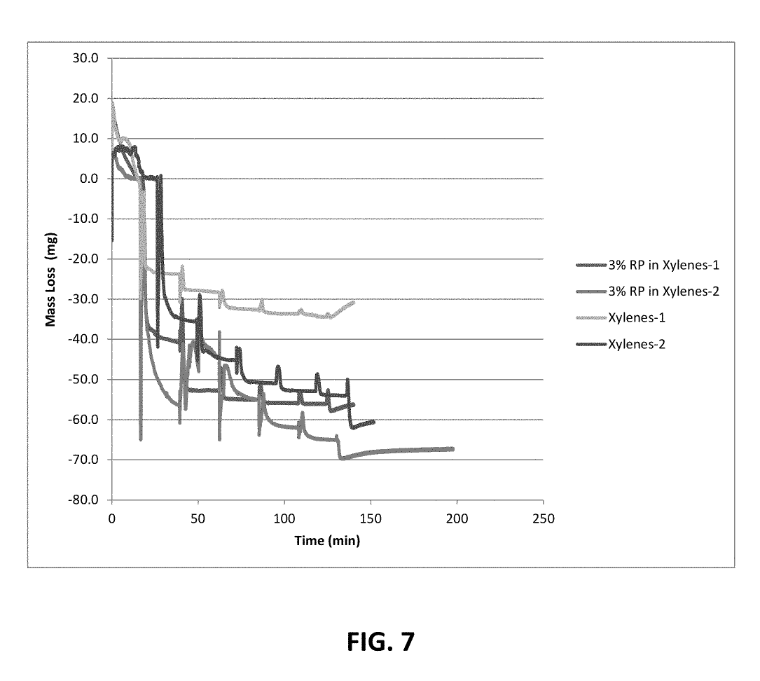

FIG. 5 illustrates the test results of the 3% RP in Xylenes-1 and 3% RP in Xylenes-2 formulations as compared to the first Xylene Control. As is shown, the 3% RP in Xylenes-1 and 3% RP in Xylenes-2 formulations have increased performance over the control showing more mass loss than the first Xylenes Control solution. FIG. 6 illustrates the test results of the 3% RP in Xylenes-1 and 3% RP in Xylenes-2 formulations as compared to the second Xylene Control. As is shown, the 3% RP in Xylenes-1 and 3% RP in Xylenes-2 formulations have increased performance over the control showing more mass loss than the second Xylenes Control solution. FIG. 7 illustrates the test results of the 3% RP in Xylenes-1 and 3% RP in Xylenes-2 formulations as compared to both the first and second Xylene Control solutions. The 2 experiments for each, however, represent an observed variability within the set of experiments. As is shown in FIG. 7, there is more variability in the Example RP formulations as compared to the Xylene control solutions but nevertheless the example RP cleaning solutions outperform the controls even with the variability.

### Example 3

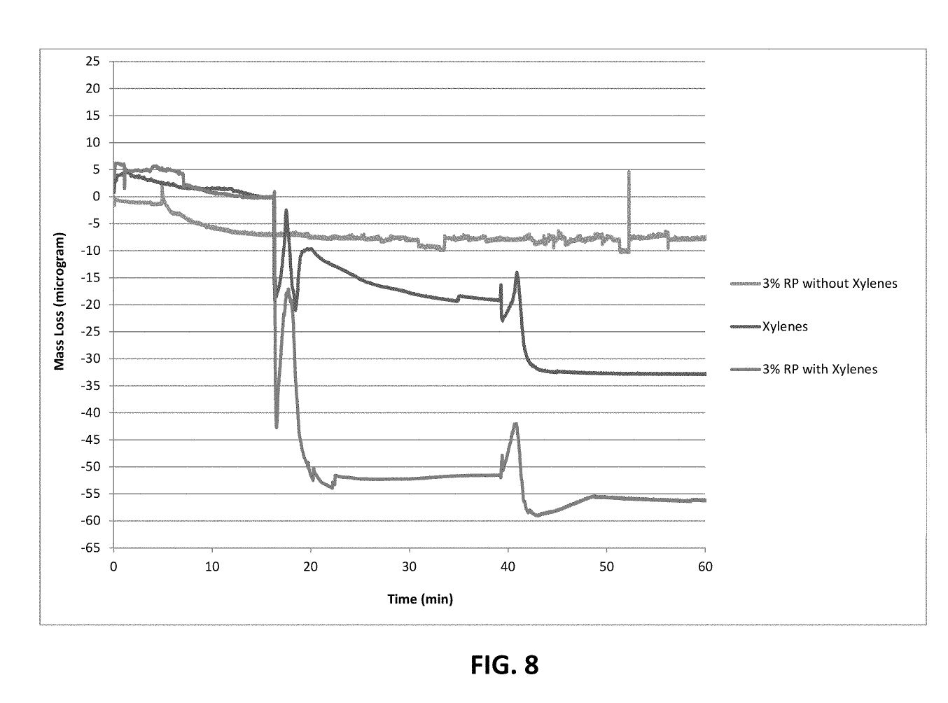

A third example was prepared to show the synergistic effect of the cleaning solutions described herein. Specifically, a formulation containing 3% RP cleaning solution without xylene (“3% RP without Xylenes”) was prepared in the same manner as the 3% RP with Xylenes-1 formulation of Example 2 replacing the xylene solvent with methanol. This 3% RP without Xylenes formulation was then tested as described above in a Quartz Crystal Microbalance with Dissipation (QCM-D) monitoring system. These results were compared against a Xylene Control and a 3% RP formulation with xylene formulated as described above in Example 2. FIG. 8 illustrates these test results. As shown, the “3% RP without Xylenes formulation showed only minimal effectiveness at producing mass loss of asphaltene deposits. Moreover, the combination of the 3% RP formulation with xylene (“3% RP with Xylenes”) shows significant mass loss relative to either xylene alone or 3% RP formulation alone. As such, the combination of the disclosed cleaning solutions—e.g., 3% RP formulation as described above—exhibits marked synergism when combined with an aromatic—e.g., xylene.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A cleaning solution for the removal of asphaltene deposits, comprising:
a first dispersant comprising a quaternary ammonium compound; and
a second dispersant comprising a pyridinium compound.

2. The cleaning solution of claim 1, further comprising an alcohol.

3. The cleaning solution of claim 1, wherein the first dispersant is selected from the group consisting of: trimethyl alkyl quaternary ammonium compounds, dialkyldimethyl quaternary ammonium compounds, alkyl dimethyl or diethyl benzyl ammonium compounds, polyethoxylated quaternary ammonium compounds, polymeric betaines, salts thereof, or mixtures thereof.

4. The cleaning solution of claim 1, wherein the first dispersant is selected from the group consisting of cocotrimethyl ammonium chloride, didecyl dimethyl ammonium chloride, didecyl dimethyl ammonium carbonate, didecyl dimethyl ammonium bicarbonate, dioctyl dimethyl ammonium chloride, octyl decyl dimethyl ammonium chloride, benzalkonium chloride, benzalkonium hydroxide, N,N-didecyl-N-methyl-poly(oxyethyl) ammonium propionate, N,N-didecyl-N-methyl-poly(oxyethyl) ammonium lactate, salts thereof, or mixtures thereof.

5. The cleaning solution of claim 1, wherein the first dispersant is a dialkyldimethyl quaternary ammonium compound, or a salt thereof.

6. The cleaning solution of claim 1, wherein the first dispersant is didecyl dimethyl ammonium chloride.

7. The cleaning solution of claim 1, wherein the pyridinium compound is selected from the group consisting of: cetyl pyridinium, 1-(phenylmethyl)-pyridinium, 1-ethylmethyl pyridinium, 1-methyl pyridinium, 1-ethyl pyridinium, 1 propyl pyridinium, 1-butyl pyridinium, salts thereto, and mixtures thereof.

8. The cleaning solution of claim 1, wherein the pyridinium compound is a 1-alkylpyridinium chloride salt.

9. The cleaning solution of claim 2, wherein the alcohol is selected from the group consisting of: ethanol, methanol, isopropanol, or mixtures thereof.

10. The cleaning solution of claim 1, further comprising an aromatic hydrocarbon solvent.

11. The cleaning solution of claim 10, wherein the aromatic hydrocarbon solvent comprises at least one of toluene or xylene.

12. The cleaning solution of claim 10, wherein the aromatic hydrocarbon solvent comprises a high aromatic naphtha.

13. The cleaning solution of claim 1, wherein the cleaning solution is a concentrate.

14. The cleaning solution of claim 1, wherein the second dispersant is present at an actives ratio of 1:10 to 10:1 to the concentration of the first dispersant.

15. A method of removing asphaltene deposits from a system, comprising flushing a system component having asphaltene deposits with an asphaltene cleaning solution comprising a quaternary ammonium compound and a pyridinium compound.

16. The method of claim 15, wherein flushing the system component comprises a batch treatment with the cleaning solution.

17. The method of claim 15, wherein flushing the system component comprises a continuous treatment with the cleaning solution.
